(19) United States
(12) Patent Application Publication
(10) Pub. No.: US 2026/0030597 A1
(43) Pub. Date: Jan. 29, 2026

(54) APPARATUS AND METHOD OF PROVIDING PROPERTY MAINTENANCE SERVICE TO USER

(71) Applicants: Mike Younjin Kim, McLean, VA (US); Kevin Minsoo Park, Arlington, VA (US); Min Suk Kim, Chantilly, VA (US); Myung Soo Park, Front Royal, VA (US)

(72) Inventors: Mike Younjin Kim, McLean, VA (US); Kevin Minsoo Park, Arlington, VA (US); Min Suk Kim, Chantilly, VA (US); Myung Soo Park, Front Royal, VA (US)

(21) Appl. No.: 19/032,088

(22) Filed: Jan. 19, 2025

Related U.S. Application Data
(60) Provisional application No. 63/676,818, filed on Jul. 29, 2024.

(51) Int. Cl. G06Q 10/20; G06Q 10/02; G06Q 30/0601

(52) U.S. Cl. CPC G06Q 10/20; G06Q 10/02; G06Q 30/0633; G06Q 30/0641

(57) ABSTRACT

A method of a computing device having a network unit, a functional unit, a user input unit, and a display panel includes displaying a screen to receive an address from a user of the computing device, determining whether the address matches a location of the computing device, displaying a user area including service providers if the address matches the location of the computing device, determining whether the user is an existing customer if the address does not match the location of the computing device, displaying the user area including the service providers if the user is the existing customer, determining whether the user is verified if the user is not the existing customer, displaying the user area including the service providers if the user is verified, and receiving a user input corresponding to one of the service provider.

### BACKGROUND OF THE INVENTIVE CONCEPT

### 1. Field of the Inventive Concept

The present inventive concept relates to an electronic apparatus and method of providing a property maintenance service to a user.

### 2. Description of the Related Art

When a user needs a service for a user house or a user property, the user has to contact a service provider to receive a relating service or to search for a service provider.

### SUMMARY OF THE INVENTIVE CONCEPT

The present inventive concept provides an electronic apparatus to provide a property maintenance service to a user.

The present inventive concept provides a method of providing a property maintenance service to a user.

The present inventive concept provides a computer readable medium to contain computer readable codes as a program to execute a method of providing a property maintenance service to a user.

Additional features and utilities of the present inventive concept will be set forth in part in the description, which follows and, in part, will be obvious from the description, or may be learned by practice of the present inventive concept.

The foregoing and/or other features and utilities of the present inventive concept may be achieved by providing a computer-readable medium containing computer-readable codes as a program to execute a method of a computing device having a network unit, a functional unit, a user input unit, and a display panel, the method including generating a screen for a service on the display panel, receiving an address from a user of the computing device, determining whether the address matches a location of the computing device, displaying a user area including service providers if the address matches the location of the computing device, determining whether the user is an existing customer if the address does not match the location of the computing device, displaying the user area including the service providers if the user is the existing customer, determining whether the user is verified if the user is not the existing customer, displaying the user area including the service providers if the user is verified, and receiving a user input corresponding to one of the service providers.

The method may further include performing a transaction corresponding to one of the service providers according to the user input.

The method may further include performing a reservation of an appointment schedule corresponding to one of the service providers according to the user input.

The user address may include a street name, and the location of the computing device includes the street name.

The user address may include an area name and the location of the computing device may include the area name.

The user address may include an area name and the location of the computing device may not include the area name.

The user address may match the location of the computing device if the user address and the location of the computing device include a same street name.

The method may determine that the address does not match the location of the computing device if the user address and the location of the computing device do not include a same street name.

The method may determine that the address matches a location of the computing device if the user address and the location of the computing device include a same area name.

The method may determine that the address does not match the location of the computing device if the user address and the location of the computing device do not include a same area name.

The user area may include an area around the location of the computing device

The user area may include an area around the user address.

The user area may include an area in a range of a distance from the user address.

The user area may include an area in a range of a distance from the location of the computing device.

The user area may include an area including a street name of the user address and neighboring streets adjacent to the street name.

The user area may include an area including a street name of the location of the computing device and neighboring streets adjacent to the street name.

The method may further include displaying a screen with an option menu including a first area of the location of the computing device and a second area around the user address, and the method may further include displaying the user area according to a selection of the first area and the second area.

The user area may include a map with street names and street numbers, and the service providers are respectively displayed on the corresponding street name and number of the map.

Each of the service providers include a service provider information, a service item, and a service fee.

The method may further include displaying a table in the user area to show service fees respectively corresponding to the service providers.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a view illustrating a screen including a map image, a service area including a user neighboring area including a user property location, service providers, and street names according to an embodiment of the present inventive concept;

FIG. 2 is a block diagram illustrating a computing device according to an embodiment of the present inventive concept;

FIG. 3 is a flowchart illustrating a method of a computing device according to an embodiment of the present inventive concept;

FIG. 4 is a flowchart illustrating a method of a computing device according to an embodiment of the present inventive concept;

FIG. 5 is a flowchart illustrating a method of a computing device according to an embodiment of the present inventive concept; and

FIG. 6 is a flowchart illustrating a method of a computing device according to an embodiment of the present inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

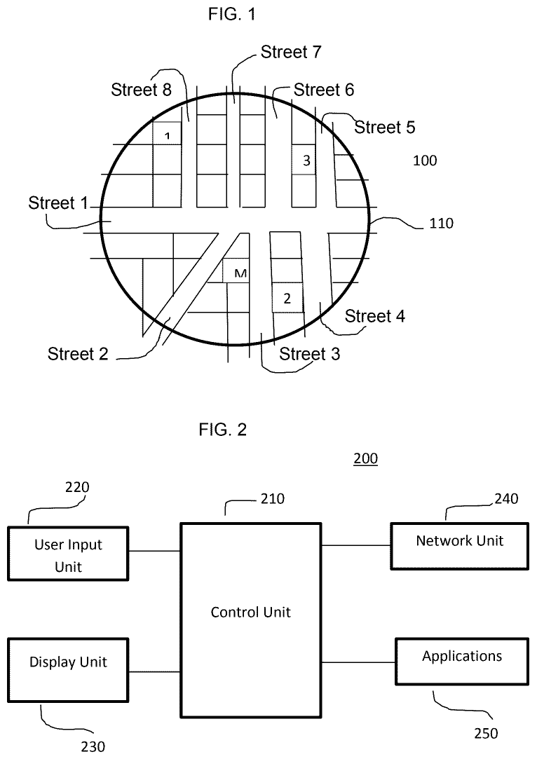

FIG. 1 is a view illustrating a screen including a map image 100, a user neighboring area 110 including a user location M, service providers 1, 2, and 3, and street names 1 through 8 according to an embodiment of the present inventive concept.

A computing device may generate a signal to display the screen including the map image (or menu image) 100 on a display panel such that a user inputs an address corresponding to a user property address to the computing device through the map image 100 of the screen. The address or user location may include a street number, a street name, a city name, a state name, and/or a zip code. The address or user location may be an area name, for example, Park road, Fairfax city. An example of the address may be ‘1600 Pennsylvania Avenue, Washington, DC 20006.’ The user address may be a user address, a property address, a user house address, or a building address. The property may be a house, building, a yard, and a surrounding area. The property may have a house size or a lot size. The house size may be 10,000 or 5000 square feet, etc., for example. The lot size may be, for example, 5 acres, 2 acres, 1 acre, 0.5 acres, etc. A service fee of the service providers may vary according to the property, the house size or the lot size. When the user inputs the address into the computing device, the computing device receives the address as the user location M and displays the map image 100 including the user neighboring area 110 corresponding to the user location M on the display panel. It is possible that the user touches a position corresponding to a user house on the map image 100 as the address when the computing device includes a touch panel to receive a touch user input from the user.

The user neighboring area 110 may be a service area around the address. The service area may include a number of properties about the address. The address may be a location of the computing device. it is a user preference or a maker's preference to select one of the user input address and the location of the computing device as the address. The preference may be set in a location setting menu as the address displayed on the screen. The user neighboring area 110 may be an area with a same street name of the address. The user neighboring area 110 may be an area including one or more streets connected to a street name of the address. The user neighboring area 110 may be an area within a range of a certain distance from the address. However, the present inventive concept is not limited thereto. The user neighboring area 110 may be an area within a boundary of a same city or county of the address. The user neighboring area 110 may be an area defined by a user preference or a design preference. The preference may be set in a preference setting menu displayed on the screen. The user neighboring area 110 may be an area which can be modified or edited by the user by changing a same street name of the address. The user neighboring area 110 may be a reduced area or enlarged area around the address. The number of service provides may be included or excluded according to the modification or edition of the preference of the address.

It is possible that the address can be recognized by the computing device when the computing device is connected to an external device, for example, a WiFi device, a Bluetooth device, or a mobile data service provider. The computing device may generate the signal to display the user neighboring area 100 with the user location M and service providers 1, 2, and 3 on the display panel.

The service providers 1, 2, and 3 may provide the same type of a service to properties in the user neighboring area 110. The properties may be a house, a building, or a yard around a housing or building structure. The service may be a mowing service. The service may be painting, plumbing, etc. The service providers 1, 2, and 3 may be a lawn care contractors or lawn mowing contractors, for example. The service may be a weed control service. The service may be a pest control service. However, the present inventive concept is not limited thereto. The service may be any service necessary to a user asset maintenance service. The service may be currently performed in the user neighboring area 110. When the user selects one of the service providers displayed on the display panel, the computing device may generate another signal to display details of the service provided by the selected service provider 1, 2, or 3, on the display panel. The details of the service providers may include service fees depending on property areas, for example, feet or acres, user may compare details of respective service providers. The details of the service providers may include service times to perform the service. The user may select one of the service providers for the maintenance service on the user property. It is possible that the screen includes a time period menu for a user to select one of time periods, for example, a month, recent months, a quarter, a year, etc. According to the selection of one of the time periods, the screen displays the service providers which have performed their services during the selected time period on the area around the user input address or the location of the computing device. The computing device may require the user a transaction to authorize the selected service. Detailed descriptions of the transaction will be omitted here since the transaction is well-known.

The computing device may determine whether the address input by the user is different from a location of the computing device. When the address is the same as the location, the computing device may generate the signal to display the map 100 including the user neighboring area 110 corresponding to the user location M on the display panel. When the address is not the same as the location, the computing device may determine one of the input address, the location of the computing device, as a property address of the user location M according to a priority given to either one of the input address and the location of the computing device. When the user is one of existing customers, the computing device may display the user neighboring area 100 according to a previously input address or a previous location, which is stored and included as existing customers in a memory of the computing device.

Since the service providers are in the user neighboring area or currently perform the service in the user neighboring area, the user may select one of the service providers according to the details of the service providers. The user may not have to retrieve service providers around the user property location or to contact respective service provides to compare services corresponding to the respective service provides. The computing device may include a program to provide a property maintenance service information to a user as described above or below. The service providers may register their service and details of the services to the computing device such that the user neighboring area includes the service providers around the user property location.

FIG. 2 is a block diagram illustrating a computing device 200 according to a present inventive concept. The computing device 200 may be an electronic terminal apparatus, a desktop computer, a computer apparatus, a laptop computer, a portable personal computer, a mobile electronic device, a mobile phone, a mobile tablet apparatus, a mobile tablet computing apparatus, an audio or video recording and/or reproducing apparatus, a photographing apparatus, a communication device, etc.

The computing device 200 may include a control unit 210, a user input unit 220, a display unit 230, a network unit 240, and an application or functional unit 250.

The control unit 210 may control operations of the terminal, communicate with the user input unit 220, the display unit 230, the network unit 240, and the application or functional unit 250. The control unit 210 may include a data storage unit, a semiconductor memory unit, a central processing unit, a user interface unit, a graphic user interface unit, and a computer-readable medium containing computer-readable codes as a program to execute a method of the computing device 200. The control unit 210 may be connected to an external data storage unit disposed in a housing of the computing device 200. The housing of the computing device 200 may include a port such that another external data storage can be detachably attached to the port of the housing, and the port may be connected to the control unit 210 to transmit and receive data.

The user input unit 220 may receive a user input to control operations of the computer device 200. The user input unit 220 may include a physical button or key board such as QWERTY keyboard. The user input unit 220 may have a sensor to detect a user gesture as a user input. The user interface unit 220 may include a microphone to detect a user voice as a user input. The user input unit 220 may be a sensor to detect an image as a user input. The display unit 230 may include a screen to display an image or one or more menus corresponding to operations of the computing device 200. The display unit 230 may include a panel including a display layer and a touch layer to perform a function to display an image and also a function to receive a user input. The user interface unit 220 and the display unit 230 may be formed as a single integrated body.

The network unit 240 may be a wires network unit or a wireless network unit. The network unit 240 may communicate with an external apparatus or a network apparatus, for example, a WiFi device, a Bluetooth device, an access point, a mobile communication station. The network unit 240 transmits data to the external apparatus and receives data from the external apparatus to perform the operations of the computing device 200. The control unit 210 may determine a location of a user or the computing device 200 according to communication between the network unit 240 and the external apparatus.

The functional unit 250 (e.g., application unit 250) may include a photographing unit or a camera to photograph an object and to generate a signal corresponding to the photographing object to unlock the computing device or authenticate an authorized user of the computing device 200. The signal may be processed in the control unit 210, displayed in the display unit 230, and/or transmitted to the external apparatus through the network unit 240. The functional unit 250 may include an audio input/output device such as a microphone and a speaker. The functional unit 250 may include a sensor to detect a user, an ambient condition, or an environmental condition to perform the operation of the computing device.

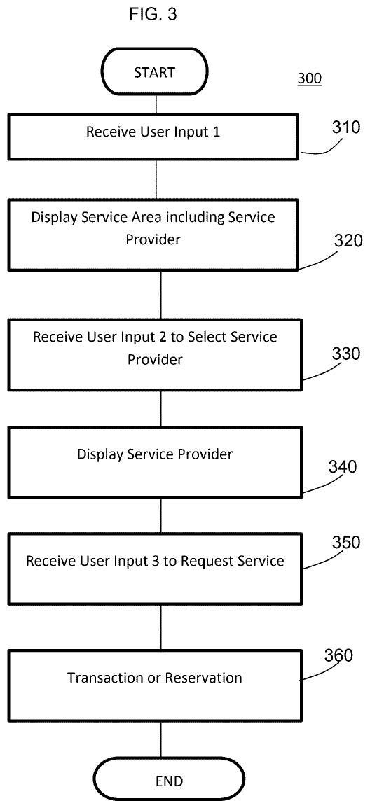

FIG. 3 is a flowchart illustrating a method 300 of a computing device according to a present inventive concept.

The method 300 may include displaying a menu on a screen of a display unit of the computing device. The menu may be a service for a house maintenance or a property maintenance. However, the service is not limited to thereto. The service may be a mowing service, a weed control service, a pest control service, or any type of service which a user demands, The method 300 may include receiving a user address or a user touch input as a user input 1 from a user in operation 310, displaying an service area including one or more service providers in operation 320 according to the user input 1 in operation 320, receiving a user input 2 to select at least one of the service providers in operation 330, displaying details of the selected service provider in operation 340, receiving a user input 3 to request the selected detail of the selected service provider in operation 350, and a transaction to authorize the requested service in operation 360. The details of the selected service provider may include a size, for example, of the user house or property. The size may be an area as square feet, for example. The details may include one or more service times, one or more frequencies, one or more service types, and/or one or more service fees. However, the details are not limited thereto. The details may include any service which a user needs to maintain a state of the user house or property. The user house or property may be defined as a user input. The user input may be an address including street number, street name, city name, county name and/or state name. The user input may be a mouse/cursor input or a key board input. The user input may be a touch input through a touch panel.

According to an embodiment of the present inventive concept, it is possible that at operation 310, when a user inputs the user input 1, the user may input a voice including an address to a microphone instead of tying the address on the panel of the mobile device as the user input 1, the mobile device can recognize the address from the voice of the address. Since converting the voice of the address into a message representing the address is well known, detailed descriptions will be omitted. In this case, the mobile device may display a window to receive a typed address or an audio address as the user input 1.

It is possible that the panel may display a menu to receive a typed address and/or an audio address as the user input 1 at operation 310. It is possible that when the panel displays the menu, the control unit 210 of FIG. 2 may activate a microphone and a speaker of the input/output device of the functional unit 250 of FIG. 2 to instruct the user to speak an address to receive the audio address as the user input 1 at operation 310.

The voice of the address may be recognized in the mobile device as the user input 1 of FIG. 3 by using a microphone of the audio input/output device of the functional unit 250 of the mobile device 200 of FIG. 2. When the audio address (or voice of address) is input to the control unit 210 of the mobile device 200 through the application unit 250, the control unit 210 may recognize the audio address as the user input 1 at operation 310.

When the method 300 displays a menu on a screen of a display unit of the computing device to receive an address, the method 300 may activate the audio input/out device of the functional unit 250. The user may type an address through the panel of the display unit 230 or speak an address through the audio input/output device of the functional unit 250. Either one of the typed address and the audio address can be usable as the user input 1.

It is possible that the mobile device may receive the typed address or the audio address as the user input 1, and then use the user input 1 at the following operations in FIGS. 3 through 6. That is, at least one of the typed address and the audio address may be respectively referred to as a user input 1, a user input of address, and a user input address, described in methods of FIGS. 3 through 6.

Hereinafter, the audio address and/or the typed address may be referred to as user inputs of the methods of FIGS. 3 through 6, for example, the user inputs 1, 2, and 3, the user input of address or the user input address.

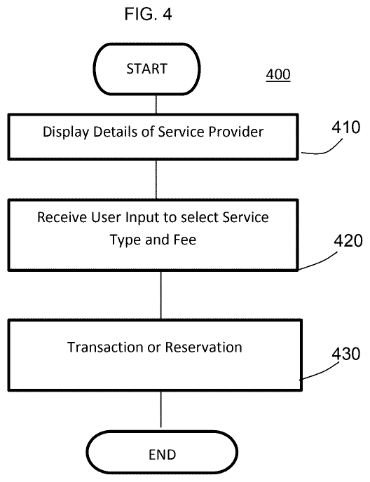

FIG. 4 is a flowchart illustrating a method 400 of a computing device according to a present inventive concept.

The method 400 may include displaying details of a service provider at operation 410, receiving a user input to select service type, frequency, and fee according to a size of a user property at operation 420, and performing a transaction to authorize the service in operation 430.

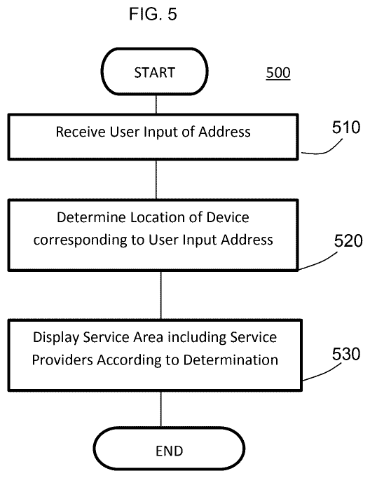

FIG. 5 is a flowchart illustrating a method 500 of a computing device according to a present inventive concept.

The method 500 may include receiving a user input at operation 510. The user input may be an address in which a user property is located. The method 500 may further include determining a location of the computing device and determining whether the location is different from the address at operation 520. The location of the computing device may be determined according to communication with an external device. The location of the computing device may be determined by using a GPS function of the computing device. The location of the computing device may be determined according to an Internet connection through the external apparatus.

When the location is not identical to or is different from the address, the method may further include an identification process to identify that the address and the location of the computing device correspond to the user. For example, the input address is in the state of Virginia and the location of the computing device is in the state of Maryland. In this case, the method determines that the address is different from the location. However, the present inventive concept is not limited thereto. The address and location are in different cities. The address and location are in different counties. It is possible that the address and location are in different streets.

The identification process may be performed by searching public records to see a computing device user is the owner of the property. The identification process may be performed by a history of the computing device. The identification process may be performed by a user ID, for example, a user biometric identification or a user face recognition, of the computing device. The identification process may be referred to as a verification process or a security process. The identification process may include sensing a text message with a security code to a user mobile device or sending an email with a security code to a user email account, display a menu requiring the user to input the security code through the user input unit, and receiving a user input of the received security code such that the method 500 displays the neighboring area according to the address. The method 500 may include displaying a service area with service providers according to the determination and/or the identification process at operation 530. That is, when the address is same as the location, the method may perform the operation 530. When the address is not same as the location, the method may perform the identification process and the operation 530.

It is possible that the address has a priority. It is possible that the location has a priority. When the address has the priority, the method 500 may perform displaying a map of the service area including the address. When the location has the priority, the method 500 may perform displaying a map of the service area including the location.

It is possible that the location of the computing device may be usable as the user input of the address. In this case, operation 310 of the method 300 may be determining a location of the computing device as the user input 1. Upon determining the location of the computing device, the method 300 may display a menu with a message that the location of the computing device is usable as the address of the user property. When a user selects the menu, the computing device may recognize the location as the user input 1 of the address according to the selected menu in operation 310 of the method 300.

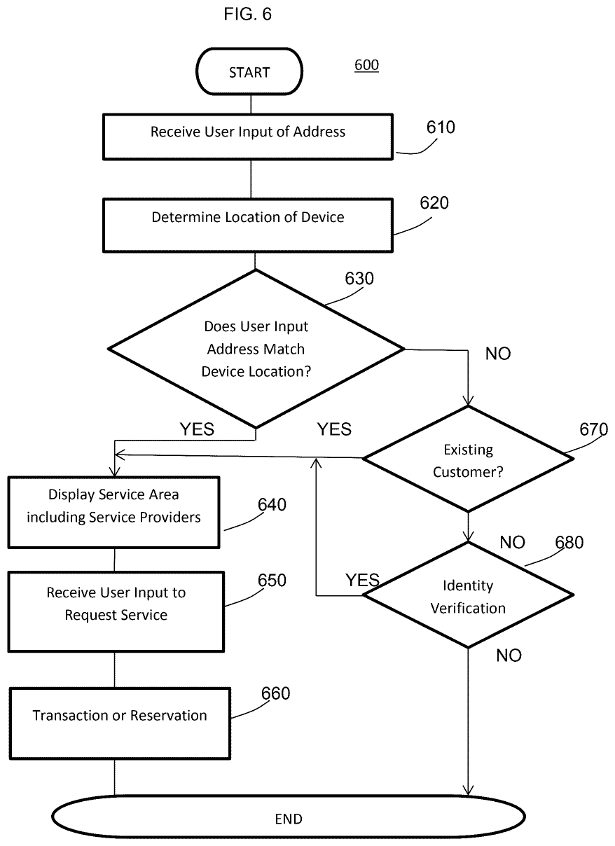

FIG. 6 is a flowchart illustrating a method 600 of a computing device according to an embodiment of the present inventive concept.

At operation 610, the computing device displays a screen on a display panel to receive a user input of address through the screen. A user of the computing device may select a service provide menu to display the screen. The screen may have a section for the user to enter the user input address through a touch screen of the display panel. The user input address may be input through a keyboard. The user address may be a first address including a first street number, a first street name, a first city name, a first county name, and/or a first state name. At operation 620, the computing device may determine a location of the computing device. Since determining the location of the computing device is well-known, details descriptions will not be omitted here. The location of the computing device may be a second address including a second street number, a second street name, a second city name, a second county name, and/or a second state name.

At operation 630, the computing device may determine whether the user input address matches the computing device location. it is possible that the user input address matches the location when the first street name matches the second street name. It is also possible that the user input address matches the location when a first area name of the user address is the same as a second area name of the computing device. The present inventive concept is not limited thereto. When any portion of the user unput address is same as a portion of the location, it may be determined that the user input address matches the location. It is possible that the user input address does not match the location when the first state name is different from the second state name.

At operation 640, a map of a service area including one or more service providers are displayed on a screen of the display panel when the user input address matches the location of the computing device. The service providers may be overlapped over the service area in the map. Since the map is well known, detailed descriptions will be omitted here. The map of the service area may be the map illustrated in FIG. 1. The service area may be an area around the user input address. It is also possible that the service area may be an area around the location of the computing device. The computing device may have a priority to display the area around the user input address as the service area. It is possible that computing device may have a priority to display the area around the location as the service area.

The user service area may include an area around the location of the

computing device when the location has a higher priority than the user input address. It is possible that the service area includes an area around the user input address when the user input address has a higher priority than the location. The service area may include an area in a range of a distance from the user address. It is possible that the service area includes an area in a range of a distance from the location of the computing device. The service area may include an area including a street name of the user input address and neighboring streets adjacent to the street name. It is possible that the service area includes an area including a street name of the location of the computing device and neighboring streets adjacent to the street name.

The service area and the service providers may be displayed to be overlapped with the map. The method may further include displaying a screen with an option menu including a first area of the location of the computing device and a second area around the user address, and the method further comprises displaying the user area according to a selection of the first area and the second area as the service area.

The service area may include a map with street names and street numbers, and the service providers may be respectively displayed on the corresponding street name and street number of the map.

The service provider may be represented by a symbol on a corresponding street name and street number on the map. The symbol includes a menu to receive a service item information from the user and a second menu to display a service fee based on the service item information. For example, information of the service item may include fee schedules on corresponding sizes of a property, and then the user may select one of the fee schedules. The symbol may include a third menu to receive a user unput for payment or reservation on the schedule appointment process for the service.

Each of the service providers may include a service provider information, a service item, and a service fee. It is possible that each of the service providers may include service information provided to a property of a street name and a street number of the service area within a time period. The method may further include displaying a table in the service area to show service fees corresponding to the respective service providers so that the user is able to compare service fees.

At operation 650, a user input is received to request a service from at least one of the service providers. At operation 660, a transaction and a reservation schedule may be performed. Since the transaction and the reservation schedule are well known, detailed descriptions will be omitted here. When

At operation 670, the computing device determines whether the user of the computing device is an existing customer when the user input address does not match the location of the computing device. A list of the existing customers may be stored in the computing device or a server connected to the computing device. Accordingly, the user of the computing device is compared with the existing customers. When the user of the computing device is the existing customer, the computing device displays the map of the service area including one or more service providers on the display panel at operation 640.

At operation 680, the computing device determines whether the user of the computing device is verified when the user of the computing device is not the existing customer. When the user of the computing device is verified, the computing device displays the map of the service area including the service providers at operation 640. When the user of the computing device is not verified, the computing device may perform operation 610 to display the screen of to receive the user input address at operation 610. Otherwise, the computing device terminates the operation thereof.

It is possible that operation 680 may verify whether a user of the computing device is an authorized user of the computing device by using a biometric method, such as a face recognition method. However, present inventive concept is not limited to the biometric method. the verification method may be a two-step verification process. Since the face recognition method and two-step verification process are well known, detailed descriptions will be omitted hereinafter. It is also possible that the biometric method can be performed before operation 610 to initiate operation 610 according to the varification.

As illustrated above, a computing device provides a user interface for a user to select a service for a user property and a service provider performing the service to a neighboring area. When a user needs a mowing service on a user property, the user may select a mowing service provider who performs the service in the neighboring area of the address or location. The user may compare mowing service providers who perform the mowing services in an area around the user property.

The service may be any service necessary to maintain a property at a certain location. The service may be any service associate with a size of a property at a certain location. The service may be any service to be provided at a neighboring area around a certain area. A user may get information of services provided to a neighboring area around a user area to compare the services before determine which one of the service providers is good for the user according to a user preference.

As stated above, a computer-readable medium may contain computer-readable codes as a program to execute a method of a computing device having a network unit, a functional unit, a user input unit, and a display panel, and the method may include generating a screen for a service on the display panel, receiving an address from a user of the computing device, determining whether the address matches a location of the computing device, displaying a service area including service providers if the address matches the location of the computing device, determining whether the user is an existing customer if the address does not match the location of the computing device, displaying the user area including the service providers if the user is the existing customer, determining whether the user is verified if the user is not the existing customer, displaying the service area including the service providers if the user is verified, and receiving a user input corresponding to one of the service providers.

According to embodiments of the present inventive concept, the method may further include performing a transaction corresponding to one of the service providers according to the user input, and may further include performing a reservation of an appointment schedule corresponding to one of the service providers according to the user input.

According to embodiments of the present inventive concept, the user address may include a street name, and the location of the computing device may include the street name. The user address may include an area name and the location of the computing device may include the area name, The user address may include an area name and the location of the computing device may not include the area name.

According to embodiments of the present inventive concept, the user address may match the location of the computing device if the user address and the location of the computing device include a same street name.

According to embodiments of the present inventive concept, the method may determine that the address does not match the location of the computing device if the user address and the location of the computing device do not include a same street name, that the user input address matches a location of the computing device if the user input address and the location of the computing device include a same area name, and/so that the address does not match the location of the computing device if the user input address and the location of the computing device do not include a same area name.

According to embodiments of the present inventive concept, the service area may include an area around the location of the computing device, an area around the user address, and/or an area in a range of a distance from the user input address.

According to embodiments of the present inventive concept, the service area may include an area in a range of a distance from the location of the computing device, an area including a street name of the user address and neighboring streets adjacent to the street name, and/or an area including a street name of the location of the computing device and neighboring streets adjacent to the street name.

According to embodiments of the present inventive concept, the method may further include displaying a screen with an option menu including a first area of the location of the computing device and a second area around the user address, and the method may further include displaying the user area according to a selection of the first area and the second area.

According to embodiments of the present inventive concept, the user area may include a map with street names and street numbers, and the service providers are respectively displayed on the corresponding street name and number of the map.

According to embodiments of the present inventive concept, each of the service providers include a service provider information, a service item, and a service fee.

According to embodiments of the present inventive concept, the method may further include displaying a table in the user area to show service fees respectively corresponding to the service providers.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a read-only memory (ROM), a random-access memory (RAM), a flash memory, a semiconductor chip package, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A computer-readable medium containing computer-readable codes as a program to execute a method of a computing device having a network unit, a functional unit, a user input unit, and a display panel, the method comprising:
generating a screen for a service map on the display panel;
receiving a user input address through the screen;
determining whether the user input address matches a location of the computing device;
displaying a service area including service providers according to the determination that the user input address matches the location of the computing device; and
receiving a user input corresponding to one of the service providers to provide the user with detail services of the one service provider.

2. The medium of claim 1, wherein the method further comprises:
determining whether a user is an existing customer if the user input address does not match the location of the computing device; and
displaying the service area including the service providers according to the determination that the user is the existing customer.

3. The medium of claim 1, wherein the method further comprises:
determining whether a user is verified if the user is not an existing customer; and
displaying the service area including the service providers if the user is verified.

4. The medium of claim 1, wherein the method further comprises:
determining whether a user is an existing customer if the address does not match the location of the computing device;
displaying the service area including the service providers if the user is the existing customer;
determining whether the user is verified if the user is not the existing customer; and
displaying the service area including the service providers if the user is verified.

5. The medium of claim 1, wherein the method further comprises performing a transaction corresponding to one of the service providers according to the user input.

6. The medium of claim 1, wherein the method further comprising performing a reservation on an appointment schedule corresponding to one of the service providers according to the user input.

7. The medium of claim 1, wherein it is determined that the user input address matches the location when the user input address and the location include a same street name.

8. The medium of claim 1, wherein it is determined that the user input address matches the location when the user input address and the location include a same area name.

9. The medium of claim 1, wherein the user service area includes an area around the location of the computing device when the location has a higher priority than the user input address.

10. The medium of claim 1, wherein the service area includes an area around the user input address when the user input address has a higher priority than the location.

11. The medium of claim 1, wherein the service area includes an area in a range of a distance from the user address.

12. The medium of claim 1, wherein the service area includes an area in a range of a distance from the location of the computing device.

13. The medium of claim 1, wherein the service area includes an area including a street name of the user input address and neighboring streets adjacent to the street name.

14. The medium of claim 1, wherein the service area includes an area including a street name of the location of the computing device and neighboring streets adjacent to the street name.

15. The medium of claim 1, wherein the service provider includes a menu to receive a service item and a second menu to display a service fee based on the service item.

16. The medium of claim 1, wherein the method further comprises displaying a screen with an option menu including a first area of the location of the computing device and a second area around the user address, and the method further comprises displaying the user area according to a selection of the first area and the second area as the service area.

17. The medium of claim 1, wherein the service area comprises a map with street names and street numbers, and the service providers are respectively displayed on the corresponding street name and street number of the map.

18. The medium of claim 1, wherein each of the service providers includes a service provider information, a service item, and a service fee.

19. The medium of claim 1, wherein each of the service providers includes service information provided to a property of a street name and a street number of the service area within a time period.

20. The medium of claim 1, wherein the method further comprises displaying a table in the service area to show service fees corresponding to the respective service providers.
